(19) United States
(12) Patent Application Publication
(10) Pub. No.: US 2009/0218845 A1
(43) Pub. Date: Sep. 3, 2009

(54) VISOR AND METHOD OF MAKING A VISOR

(75) Inventor: Brent D. Rockafellow, Holland, MI (US)

Correspondence Address: FOLEY AND LARDNER LLP;SUITE 500, 3000 K STREET NW, WASHINGTON, DC, 20007, US

(73) Assignee: Johnson Controls Technology Company, Holland, MI (US)

(21) Appl. No.: 12/160,086

(22) PCT Filed: Jan. 4, 2007
(86) PCT No.: PCT/US07/00219

§ 371 Date: Nov. 25, 2008

Related U.S. Application Data
(60) Provisional application No. 60/756,987, filed on Jan. 6, 2006.

(51) Int. Cl. B60J 3/00

(52) U.S. Cl. 296/97.5; 296/97.1

(57) ABSTRACT

A visor assembly, comprises a first core piece having an aperture and a second core piece coupled to the first core piece. A reflective film is positioned in a tensioned state between the first core piece and the second core piece such that a first portion of the reflective film is visible through the aperture.

### CROSS-REFERENCE TO RELATED APPLICATIONS

The present application claims the benefit of U.S. Provisional Application No. 60/756,987, filed Jan. 6, 2006, which is incorporated herein by reference in its entirety.

### BACKGROUND

The present invention relates generally to the field of visors for use in vehicles and methods for making such visors. More specifically, the present invention relates to visors for vehicles (or other applications) having two core pieces, where one of the core pieces may be adapted to additionally function as a bezel for a vanity mirror and a lens for a vanity lamp. Additionally, the present invention relates to the use of a metalized polyfilm as a vanity mirror and as a reflector for a vanity lamp.

Visors to use in vehicles to shield occupants from sunlight are generally known. Such visors often have a “butterfly” or “clamshell” type core portion made from a material such as cardboard or polypropylene with generally symmetrical halves that connect together to form a joint or seam about a perimeter edge of the visor. Alternatively, the halves may be two separate core elements that are fastened together during assembly of the visor. The visors may be at least partially covered by a cover material such as a fabric.

Visors may include components such as a vanity mirror and a vanity lamp or light. These components are often integrated within a housing that is then assembled into a recess located in one or more core portions of the visor assembly. After creating the recess, the vanity housing, having the mirror and/or lamp components installed, is attached to the visor.

A vanity housing described above, having both a mirror and lamp, typically comprises several components. These components include a cover or lid for the vanity, a mirror, a bezel, housing, or frame to hold the mirror in place, a light or bulb for the lamp, and reflector and lens components for the lamp. The various components are mounted within the vanity housing, which is in turn mounted to the visor. Various hardware, adhesive materials, or other fastening devices may be required to assemble the various components into the vanity housing and in turn into the visor assembly.

One challenge associated with traditional visors is minimizing the number of components involved in providing a vanity mirror and/or lamp. Ideally, the number of components required should be minimized, therefore easing the assembly process, production costs, and the overall assembly time.

Accordingly, it would be desirable to provide a visor assembly having a film that could be tensioned and act as both a thin, lightweight, and non-distorted vanity mirror and the reflector for the vanity lamp.

It would also be desirable to provide a visor having a two piece core design with one core piece that could also function as a bezel for a vanity mirror, It would also be desirable to provide a visor having a core piece that could also function as a lens for a vanity lamp. It would also be desirable to provide a visor having a core piece that could also function as a housing for the wiring and/or switching components required to control and power a vanity lamp. It would also be desirable to provide a visor having a core piece that could also function as a pivot housing or socket for a vanity cover or lid.

Accordingly, it would be desirable to provide a visor and method for making a visor having one or more of these or other advantageous features.

### SUMMARY

According to one embodiment, a visor assembly includes a first core piece having an aperture and a second core piece coupled to the first core piece. A reflective film is positioned in a tensioned state between the first core piece and the second core piece such that a first portion of the reflective film is visible through the aperture.

According to another embodiment, a method of making a visor includes providing a first core piece and a second core piece, positioning a reflective film between the first core piece and the second core piece, and securing the first core piece to the second core piece with the reflective film there between and tensioning the reflective film, wherein at least a first portion of the reflective film is visible through an aperture in the first core piece.

According to yet another embodiment, a method of making a visor includes providing a reflective film, inserting the reflective film into a mold, injecting a molten plastic into the mold to form a first core piece, and securing the first core piece to a second core piece having an aperture such that at least a portion of the reflective film is visible through the aperture.

### BRIEF DESCRIPTION OF THE DRAWINGS

FIG. 1 is a perspective view of a visor assembly according to an exemplary embodiment;

FIG. 2 is a sectional view of the visor assembly of FIG. 1;

FIG. 3 is a partial exploded view of the visor assembly of FIG. 1;

FIG. 4 is a sectional view of a visor assembly according to another exemplary embodiment;

FIG. 5 is a partial exploded view of the visor assembly of FIG. 4;

FIG. 6 is a partial sectional view of the visor of FIG. 4;

FIG. 7 is an illustration of both sectional and perspective views of various configurations for a mirror to be used in a visor assembly according to various exemplary embodiments; and

FIG. 8 is an illustration of sectional views of various configurations for a peripheral seam for a visor assembly according to various exemplary embodiments.

### DETAILED DESCRIPTION

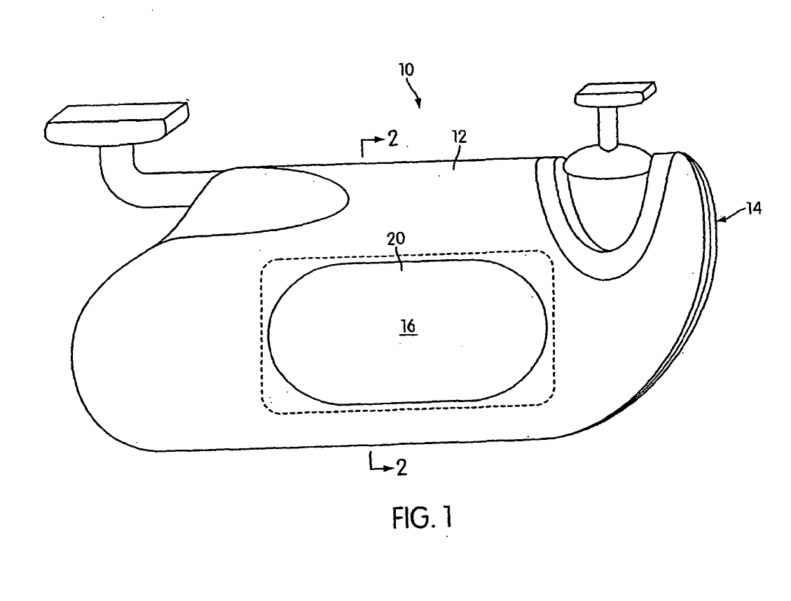

Referring to FIG. 1, a visor 10 includes a first or top core piece 12, a second or bottom core piece 14, and a vanity mirror 16. Top core piece 12 has an aperture 20 configured to allow an occupant of a vehicle to view vanity mirror 16 located between top core piece 12 and bottom core piece 14 according to an exemplary embodiment. As discussed in more detail below, top core piece 12 may also function as one or both of a vanity mirror bezel and a vanity lamp lens.

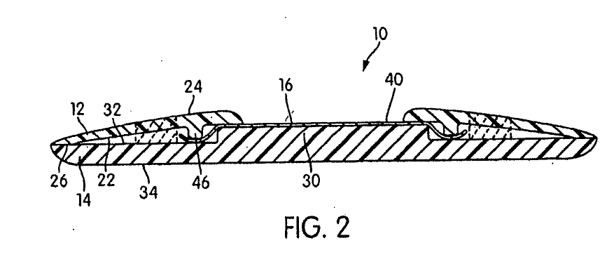

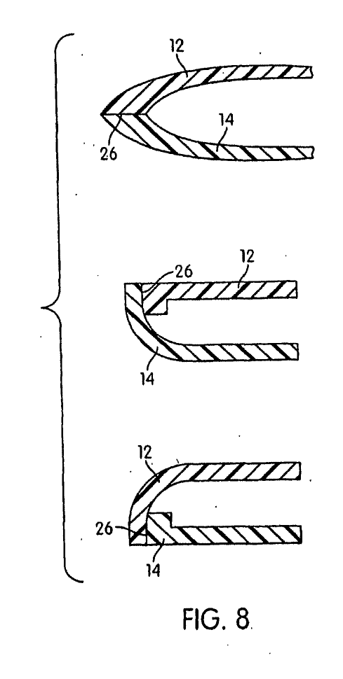

Referring to FIG. 2, top core piece 12 has an inner surface 22 and an outer surface 24. Bottom core piece 14 similarly has an inner surface 32 and an outer surface 34. Bottom core piece 14 is configured to have a peripheral configuration shown as substantially symmetrical to the peripheral configuration of top core piece 12, so that core pieces 12, 14 form a peripheral seam or joint 26 when assembled. As shown in FIG. 8, peripheral seam 26 may comprise various configurations for top and bottom core pieces 12, 14 at the interface for peripheral seam 26.

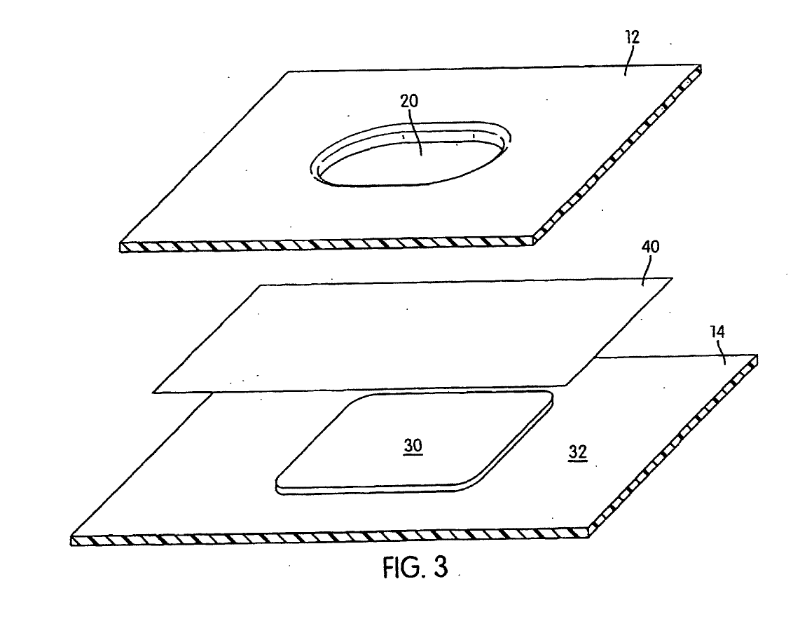

Referring to FIGS. 2 and 3, inner surface 32 may have a raised region 30 (e.g., base, platform, etc.) that is proximate aperture 20 in top core piece 12 when visor 10 is assembled. Raised region 30 provides a surface on which mirror 16 (e.g., a metalized, reflective film) may be mounted and may act as a backing surface or structure for the mirror material. In an alternative embodiment, raised region 30 may extend beyond aperture 20 in top core piece 12 when visor 10 is assembled to assist in positioning and securing mirror 16 in place (e.g., by an interference fit of the top and bottom core pieces 12, 14).

According to one embodiment, mirror 16 may be made from a film or polyfilm 40 (see FIG. 3). Film 40 may be metalized on at least one surface so as to be reflective and suitable for use as mirror 16. To avoid distortion of film 40, film 40 may be tensioned or stretched as it is assembled into visor 10. Referring to FIGS. 2 and 3, film 40 is positioned above inner surface 32 of bottom core piece 14 so that the reflective surface of film 40 is facing inner surface 22 of top core piece 12 when visor 10 is assembled. If bottom core piece 14 includes raised region 30, film 40 may be preferably positioned so as to cover the entire surface of raised region 30 that would otherwise be visible through aperture 20 in top core piece 12 when visor 10 is assembled. In use, visor 10 is rotated down from a stowed position, and film 40 is visible through aperture 20 in top core piece 12 by an occupant of a vehicle.

Referring again to FIG. 2, top core piece 12, bottom core piece 14, and film 40 may be configured in various ways. In order to hold film 40 in a tensioned position, film 40 may be provided with an adhesive backing, or be configured to be heat sealed, thermal-welded, ultrasonically welded, or captured between top and bottom core pieces 12, 14 in an interference, snap, or compression type fit. For example, as shown in FIG. 2, top and bottom core pieces 12, 14 may have one or more ridges or projections 46 configured to secure top core piece 12, film 40, and bottom core piece 14 together and maintain tension in film 40. A plurality of projections such as ridges 46 (or other suitable structure) may be used and located on either or both of top or bottom core pieces 12, 14. In addition to securing film 40, ridge or ridges 46 may also act to help secure top and bottom core pieces 12, 14 together through heat sealing, thermal or ultrasonic welding, a snap or interference fit, or any other suitable means. Further, projections or ridges 46 may be used to provide tension in film 40 when visor 10 is assembled, e.g., by stretching film 40 into a recess, etc.

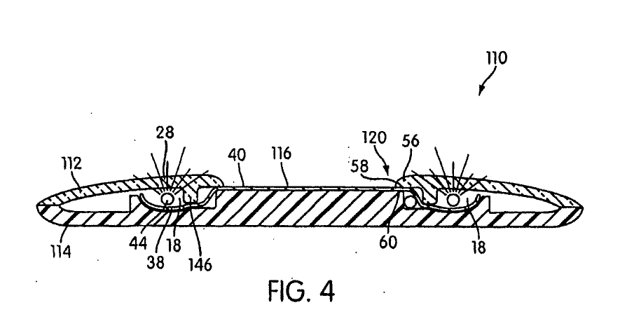

As shown in FIGS. 1-3, top core piece 12 is constructed of a plastic material and is provided without a fabric covering according to one embodiment. Bottom core piece 14 may likewise be made of a plastic material and provided without a fabric covering. In an alternative embodiment, bottom core piece 14 may be made of plastic or any other suitable material (e.g., cardboard), and then covered by a material (e.g., fabric, vinyl, leather, etc.) in a color or material texture chosen, for example, to match or contrast with the interior of a vehicle. According to an alternative embodiment, top core piece 12 may additionally serve as a pivot housing or socket for a cover or lid for vanity mirror 16 and/or a lamp 18 (see FIG. 4). The cover or lid is intended to conceal mirror 16 and/or lamp 18 from view when not in use, and be either slid or rotated open to allow viewing of mirror 16 and/or lamp 18. Top core piece 12 may have a base for a slide cover or lid, or an integrally molded pivot housing or socket.

Referring now to FIG. 4, film 40 may be adapted to be used as a reflector material 38 for vanity lamp 18 in a visor 110. A top core piece 112 may be configured to house a light source, shown as lamp 18, and the associated wires and/or switching components to power and control lamp 18. For example, visor 110 shown in FIG. 4 has lamps 18 located on each side of mirror 116. Each lamp 18 includes reflector element 38, a light or bulb 44 (e.g., an illumination source or element), a lens element 28 (shown, for example, as part of top core piece 112), and any wiring or switching components (not shown) that may be housed within visor 110. Lens 28 allows light to pass through itself when lamp 18 is in use. Bulb 44 provides the light for lamp 18 and is located between lens 28 and reflector element 38. Reflector element 38 reflects the light emitted from bulb 44 back through lens 28.

According to one embodiment, as shown in FIG. 4, film 40 acts as reflector 38 and may be held in position between top core piece 112 and a bottom core piece 114 using any suitable method such as adhesives, heat sealing, or any other suitable fastening device. Film 40 may be sized so as to extend beyond the perimeter of an aperture 120 in top core piece 112 and beneath the light elements or bulbs 44 of lamps 18 on either side of mirror 116. As shown in FIG. 4, one or more projections or ridges 146 may be positioned, for example, between mirror 116 and lamp 18 to secure film 40 in position. Ridges 146 may be configured so as to provide contact between film 40 and ridge 146 across substantially all or a portion of a transverse portion of film 40 orientated along a longitudinal direction of visor 110. A number of other suitable means of fastening film 40 in place may alternatively be used. In an exemplary embodiment, film 40 may be held in position in a tensioned state. The tension in film 40 is intended to ensure a good reflective surface, enabling film 40 to act as vanity mirror 116, and to eliminate distortion of film 40 that might occur if film 40 were installed in an untensioned state or injection molded in place.

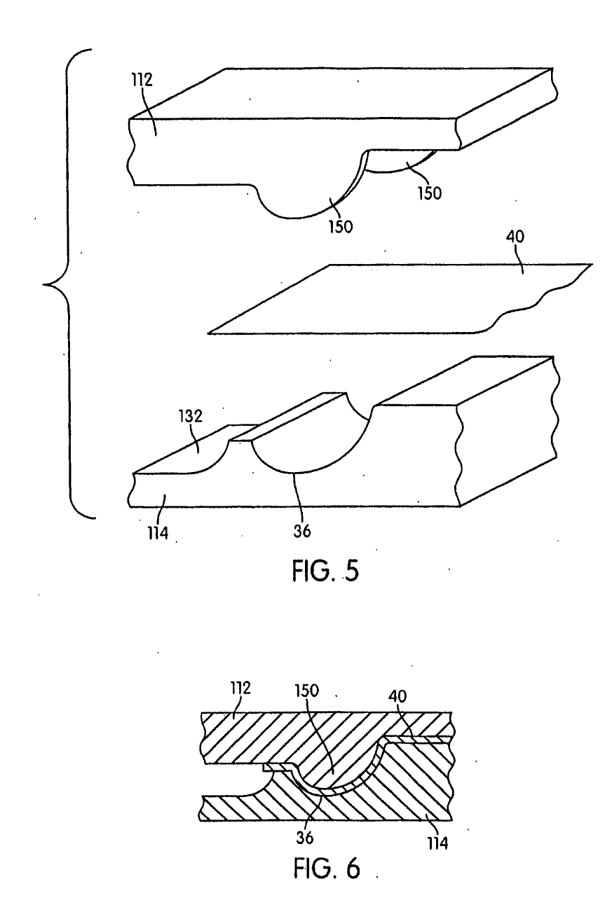

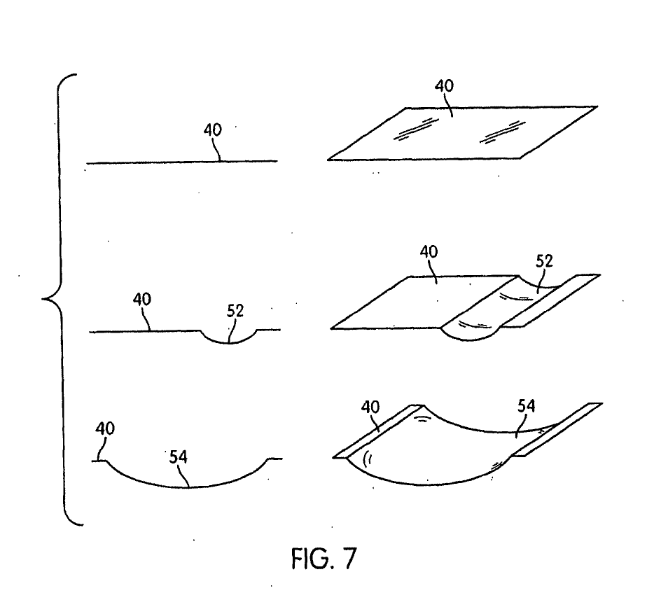

As shown in FIGS. 5 and 6, film 40 may also be installed so as to substantially conform to a concave contour 36 of inner surface 132 of bottom core piece 114 in the areas proximate the vanity bulb 44. Projections or ribs 150 in top core piece 112 are configured to match contour 36 of bottom core piece 114 and hold film 40 in a position conforming to contour 36 in bottom core piece 114. Although FIGS. 5 and 6 show film 40 acting as reflector 38, film 40 may similarly conform to a contour in bottom core 114 piece when acting as mirror 116 (e.g., to provide a magnification area of the mirror) as shown in FIG. 7. As shown in FIG. 7, film 40 may be used without a curved surface, with a relatively small contoured or curved surface 52, or with a relatively large contoured or curved surface 54. When acting as mirror 116 with a contour, similar mounting features may be used as those used to secure film 40 as reflector 38.

Referring back to FIG. 4, according to yet another embodiment, visor 110 is made at least partially from a transparent or translucent material (e.g., injection molded plastic, etc.) and includes aperture 120, a bezel portion 56, and lens portion 28. Integrating lens 28 and the bezel 56 into top core piece 112 is intended to minimize the number of components required as a part of visor 110. Additionally, top core piece 112 may also function as a housing or frame for the wiring and switching components associated with lamp 18. Top core piece 112 may be textured so that in areas outside lens portion 28, top core piece 112 does not allow visibility to other components secured within top core piece 112. Additionally, top core piece 112 could be painted, have graphics applied (e.g., screen printing, etc.) or have a “smoke” tint.

Bezel portion 56 of top core piece 112 acts as a bezel for mirror 116, being located in the area proximate the perimeter of aperture 120, and securing mirror 116 in place without the need for a separate bezel element. As shown in FIG. 4, bezel portion 56 has an outer surface 58 (i.e., the surface visible to a passenger in a vehicle) and an inner surface 60 (i.e., the surface opposite the outer surface). Outer surface 58 of bezel portion 56 generally follows the contour of top core piece 112 and curves toward the surface of mirror 116. Inner surface 60 of bezel portion 56 may be configured so that as top and bottom core pieces 112, 114 are assembled, bezel portion 56 is biased toward bottom core piece 114, thereby helping to secure mirror 116 in place. Inner surface 60 of bezel portion 56 may alternatively be contoured to receive one or more of the peripheral edges of a mirror.

Further referring to FIG. 4, lens portion 28 of top core piece 112 is located proximate bulb 44 for the vanity lamp 18 when visor 110 is assembled. Lens portion 28 may be fully transparent (i.e., tending not to diffuse the light provided by the vanity lamp bulb), or it may be translucent. The translucence may be created by using a tinted material in lens portion 28, by applying a translucent coating to lens portion 28, by providing a surface texture on one or both of the interior or exterior surface of lens portion 28, or by any other suitable means.

Bezel portion 56 and lens portion 28 of top core piece 112 may be molded as part of a single-piece top core, or they may be molded in separate molding processes (e.g., insert molded) into top core piece 112, thereby allowing for greater variances of color, material, surface texture, etc. Alternatively, lens portion 28 and bezel portion 56 may be molded as separate pieces and then mechanically attached (e.g., by a snap or interference fit, or with the use of traditional fasteners) to the top core piece 112.

The various visor components disclosed and described herein as exemplary embodiments of the invention may be utilized in the assembly of a visor using a streamlined method of assembly that is intended to reduce the typical assembly time of visors and minimize material costs. According to an exemplary embodiment, a top core piece and bottom core piece are provided, the top core piece having an aperture configured to allow viewing of a mirror contained between the inner surfaces of the top core and the bottom core pieces. The top core and bottom core pieces may be made of any suitable material.

A mirror made of a metalized film is provided, having at least one reflective surface suitable for use as both a mirror and a vanity lamp reflector, and the top core and bottom core pieces are assembled together with the mirror being captured between the top and bottom core pieces such that at least a portion of the mirror is visible through the aperture in the top core piece. Additionally, the film may be tensioned during assembly so as to avoid distortion of the reflective properties of the film.

In another embodiment, a vanity lamp is additionally provided. The film is configured to act as a reflector for the vanity lamp. The film extends between the lamp bulb and the bottom core piece and is secured in place. Alternatively, the film may conform to a contour in the inner surface of the bottom core piece.

The bottom core piece and the film material may be joined together using heat sealing. The top and the bottom core pieces are joined together using any suitable means, including heat staking, interference fits, or a “shark tooth” configuration on one of the core pieces. Additionally, projections or ridges may be provided on one or both of the core pieces, as disclosed herein, to facilitate joining of the pieces. Additional means of joining the various components include thermal and ultrasonic welding.

In another embodiment, a mold is provided and the top core piece is made at least partially of a molded plastic material such that the top core piece may function as both a bezel for a vanity mirror and a lens for a vanity lamp. The areas of the top core piece covering the vanity light or bulb are translucent or transparent so as to allow the light from the bulb to pass through. The areas of the top core piece outside the lens portion may be textured or otherwise treated or manufactured so as to obscure visibility of any other components within the visor. The bottom core piece may be injection molded with a reflective film using an injection molding process such as insert molding or a mold-behind process.

According to any of these or other exemplary embodiments, other components may be attached to the visor, such as accessories and mounting devices to suit other desired applications.

The construction and arrangement of the elements of the visor and the methods for making a visor as shown in the illustrated and other exemplary embodiments are illustrative only. Although only a few embodiments of the present invention have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited herein (e.g., the core pieces may be formed from any suitable material and may be integrated with the other elements using any suitable process). For example, elements shown as integrally formed may be constructed of multiple parts or elements, the position of elements may be reversed or otherwise varied, and the nature or number of discrete elements or positions may be altered or varied (e.g., the bezel portion and lens portions may be provided in any suitable shape, size, and location, or may be combined with one another in any suitable combination). Additionally, the film may be assembled into the visor as a mirror and/or reflector using a mold process such as an insert molding process or a partial mold behind mold process. The film may also be die cut so that it can be wrapped easily into complex shapes. In addition, the film may be used as a reflector in an overhead console or as a conversation mirror, being provided as a separate component or integrated into the overhead storage console (e.g., into a storage door or sunglass storage door).

It should be noted that the elements and/or assemblies of the visor may be constructed from any of a wide variety of materials that provide sufficient strength or durability, including any of a wide variety of moldable plastic materials (such as high-impact plastic), or foams, polymers, etc. and in any of a wide variety of colors, textures and combinations. The film may be made of any suitable film or polyfilm material that may act as both a mirror and a light reflector and may be attached in any suitable method, including application to a visor core piece directly or indirectly from a rolled good. The shape and size of the film may be varied to improve the appearance, formability, and assembly of the visor and the visor sub-components. Other substitutions, modifications, changes, and omissions may be made in the design, operating conditions, and arrangement of the preferred and other exemplary embodiments without departing from the scope of the present inventions.

The order or sequence of any process or method steps may be varied or re-sequenced according to alternative embodiments, Other substitutions, modifications, changes and omissions may be made in the design, operating configuration, and arrangement of the preferred and other exemplary embodiments without departing from the spirit of the present invention.

What is claimed is:

1. A visor assembly, comprising:
a first core piece having an aperture;
a second core piece coupled to the first core piece; and
a reflective film positioned in a tensioned state between the first core piece and the second core piece such that a first portion of the reflective film is visible through the aperture.

2. The assembly of claim 1, wherein the reflective film is a metalized film.

3. The assembly of claim 1, wherein the first portion of the reflective film has a curved contour.

4. The assembly of claim 1, wherein the first portion of the reflective film is positioned over a raised portion of the second core piece.

5. The assembly of claim 4, wherein the perimeter of the aperture on the first core piece is biased toward the raised portion on the second core piece.

6. The assembly of claim I, further comprising:
a lamp assembly having an illuminating element;
wherein a second portion of the reflective film is positioned between the illuminating element and the second core piece.

7. The assembly of claim 6, wherein the second portion of the reflective film has a curved contour.

8. The assembly of claim 7, wherein the curved contour conforms to a recess in the second core piece.

9. The assembly of claim 8, wherein the first core piece includes a projection such that the reflective film is secured between the projection and the recess.

10. A method of making a visor, comprising:
providing a first core piece and a second core piece;
positioning a reflective film between the first core piece and the second core piece; and
securing the first core piece to the second core piece with the reflective film there between and tensioning the reflective film;
wherein at least a first portion of the reflective film is visible through an aperture in the first core piece.

11. The method of claim 10, wherein the reflective film is a metalized film.

12. The method of claim 10, further comprising:
providing a lamp assembly between a second portion of the reflective film and the second core piece, the lamp assembly including an illuminating element.

13. The method of claim 12, wherein the first core piece is translucent in at least an area proximate the illuminating element.

14. The method of claim 13, further comprising:
forming a curved contour in the second portion of the reflective film.

15. The method of claim 14, wherein securing the first core piece to the second core piece comprises securing the second portion of the reflective film between a recess in the second core piece and a projection on the first core piece.

16. The method of claim 10, further comprising
securing the reflective film to at least one of the first and second core pieces by one of thermal-welding and ultrasonic welding.

17. A method of making a visor, comprising:
providing a reflective film;
inserting the reflective film into a mold;
injecting a molten plastic into the mold to form a first core piece; and
securing the first core piece to a second core piece having an aperture such that at least a portion of the reflective film. is visible through the aperture.

18. The method of claim 17, further comprising:
forming a recess in the first core piece, wherein the reflective material conforms to the contour of the recess.

19. The method of claim 17, wherein at least a portion of the second core piece is one of transparent and translucent.

20. The method of claim 17, wherein the reflective film is a metalized polyfilm.

21. The method of claim 17, further comprising die-cutting the reflective film to a desired shape prior to inserting the reflective film into the mold.

22. A visor assembly, comprising:
a first core piece having an aperture;
a second core piece coupled to the first core piece thereby forming an interior;
a mirror located in the interior and visible through the aperture; and
a light source located in the interior and configured to provide light in the direction of the first core piece;
wherein the first core piece is an integrally molded piece and is one of translucent and transparent in an area proximate the light source such that the light from the light source may pass through the first core piece.

23. The visor assembly of claim 22, wherein the mirror comprises a metalized film.

24. The visor assembly of claim 23, wherein the metalized film is positioned between the light source and the second core piece.

25. The visor assembly, of claim 22, wherein the second core piece is an integrally molded piece being different from the first core piece in at least one of a color and a surface texture.
